(19) United States
(12) Patent Application Publication
(10) Pub. No.: US 2008/0144212 A1
(43) Pub. Date: Jun. 19, 2008

(54) Fixing mechanism for recording medium

(75) Inventors: Nobuyoshi Yamaoka, Kawasaki (JP); Misao Inoke, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/071,541

(22) Filed: Feb. 22, 2008

Related U.S. Application Data
(62) Division of application No. 11/035,976, filed on Jan. 18, 2005.
Application No. 11/035,976 is a continuation of application No. PCT/JP02/13822, filed on Dec. 27, 2002.

(51) Int. Cl. G11B 17/02

(52) U.S. Cl. 360/99.12

(57) ABSTRACT

A recording medium mounted on the rotary body in a recording medium drive. First and second fixing members sandwiches the recording medium around the rotary body. An elastic member is interposed at least between the first fixing member and the recording medium. The elastic member serves to enhance the friction between the first fixing member and the recording medium in the fixing mechanism. Even if an impact is applied to the recording medium, the recording medium is thus reliably prevented from shifting within a plane perpendicular to the central axis of the rotary body, namely from a lateral shift.

### BACKGROUND OF THE INVENTION

1. Field of the Invention

The present invention relates to a fixing mechanism designed to establish fixation of a recording medium such as a magnetic recording disk, for example. In particular, the invention relates to a fixing mechanism comprising a rotary body and first and second fixing members sandwiching a recording medium around the rotary body.

2. Description of the Prior Art

A magnetic recording disk as a recording medium is mounted on a spindle hub of a spindle motor in a hard disk drive (HDD). The magnetic recording disk is allowed to rotate around the central axis of the spindle hub. Servo signal data is established on the magnetic recording disk. The servo signal data is utilized to establish a circular recording track. As long as the recording track is concentric with the spindle hub, a head slider reliably follows the recording track.

A through hole is formed in the magnetic recording disk at the center of the magnetic recording disk. The through hole receives the spindle hub when the magnetic recording disk is to be mounted. Here, a smaller clearance is provided between the inner diameter of the through hole and the outer diameter of the spindle hub. The clearance enables a facilitated insertion of the spindle hub into the through hole of the magnetic recording disk in the assembling of the hard disk drive. This leads to an improved productivity. On the other hand, the clearance induces a shift of the magnetic recording disk within a plane perpendicular to the central axis of the spindle hub. The shift of the magnetic recording disk makes the recording track eccentric to the spindle hub. If the amount of the shift exceeds the track pitch of the recording tracks, the head slider cannot follow the recording track on the magnetic recording disk. In particular, a clamp cannot apply a sufficient urging force to the magnetic recording disk in the hard disk drive of a smaller size. The aforementioned shift of a magnetic recording disk tends to occur in the hard disk drive of a smaller size.

### SUMMARY OF THE INVENTION

It is accordingly an object of the present invention to provide a fixing mechanism capable of reliably preventing a lateral shift of a recording medium.

According to a first aspect of the present invention, there is provided a fixing mechanism comprising: a rotary body; a recording medium mounted on the rotary body; first and second fixing members sandwiching the recording medium around the rotary body; and an elastic member interposed between the first fixing member and the recording medium. The first fixing member may be a spacer interposed between a pair of the recording medium around the rotary body, for example.

The elastic member serves to enhance the friction between the first fixing member and the recording medium in the fixing mechanism. Even if an impact is applied to the recording medium, the recording medium is thus reliably prevented from shifting within a plane perpendicular to the central axis of the rotary body, namely from a lateral shift.

On the contrary, if the elastic member is not interposed between the first fixing member and the recording medium, the recording medium tends to shift within the aforementioned plane. The shift of the recording medium induces an eccentricity of the recording medium relative to the central axis of the rotary body. A head slider for reading and/or writing information cannot follow recording tracks on the recording medium if the amount of the shift exceeds the track pitch.

The fixing mechanism may employ a texture formed on the surface of the elastic member. Grooves may be formed on the surface of the elastic member, for example. The texture serves to further enhance the friction between the first fixing member and the recording medium. The recording medium is thus further reliably prevented from shifting in the direction perpendicular to the central axis of the rotary body.

According to a second aspect of the present invention, there is provided a fixing mechanism comprising: a rotary body; a recording medium mounted on the rotary body; first and second fixing members sandwiching the recording medium around the rotary body; and a resin film interposed between the first fixing member and the recording medium. The first fixing member may be a spacer interposed between a pair of the recording medium around the rotary body, for example. The resin film maybe made of polyimide resin having a higher coefficient of friction, for example.

The resin film serves to enhance the friction between the first fixing member and the recording medium in the fixing mechanism. Even if an impact is applied to the recording medium, the recording medium is thus reliably prevented from shifting within a plane perpendicular to the central axis of the rotary body, namely from a lateral shift.

The fixing mechanism of the type may employ a texture formed on the surface of the resin film. The texture serves to further enhance the friction between the first fixing member and the recording medium. The recording medium is thus further reliably prevented from shifting in the direction perpendicular to the central axis of the rotary body.

According to a third aspect of the present invention, there is provided fixing mechanism comprising: a rotary body; a recording medium mounted on the rotary body; first and second fixing members sandwiching the recording medium around the rotary body; a key hole formed in either one of the first fixing member and the recording medium; and a key member fixed to the other of the first fixing member and the recording medium. The key member is designed to get into the key hole.

The key member is fitted into the key hole in the fixing mechanism of the type. A reliable fixation can be established between the first fixing member and the recording medium. Even if an impact is applied to the recording medium, the recording medium is thus reliably prevented from shifting within a plane perpendicular to the central axis of the rotary body, namely from a lateral shift. The first fixing member may be a spacer interposed between a pair of the recording medium around the rotary body, for example.

The fixing mechanism may employ integration of the key member to the other of the first fixing member and the recording medium. Alternatively, the key member may be a pin penetrating through at least one of the first fixing member and the recording medium.

In the case where the aforementioned fixing mechanisms are utilized in a recording disk drive such as a hard disk drive (HDD), the first member may be a flange formed at the lower end of the rotary body, a clamp fixed to the top of the rotary body, or the like. The aforementioned fixing mechanisms may be applied not only to a hard disk drive (HDD) but also a recording disk drive such as an optical disk drive.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive (HDD) as an example of a recording medium drive or storage device;

FIG. 2 is an enlarged vertical sectional view taken along the line 2-2 in FIG. 1;

FIG. 3 is a partial sectional view enlarged from FIG. 2, for schematically illustrating the structure of a fixing mechanism according to a first embodiment of the present invention;

FIG. 4 is an exploded view of the fixing mechanism according to the first embodiment;

FIG. 5 is a graph showing the amount of shift for magnetic recording disks according to a computer-implemented simulation;

FIG. 6 is a partial sectional view enlarged from FIG. 2, for schematically illustrating the structure of a fixing mechanism according to a second embodiment of the present invention;

FIG. 7 is an exploded view of the fixing mechanism according to the second embodiment;

FIG. 8 is a partial sectional view enlarged from FIG. 2, for schematically illustrating the structure of a fixing mechanism according to a third embodiment of the present invention;

FIG. 9 is an exploded view of the fixing mechanism according to the third embodiment; and

FIG. 10 is a partial sectional view enlarged from FIG. 2, for schematically illustrating the structure of a fixing mechanism according to a modification of the third embodiment.

### DESCRIPTION OF THE PREFERRED EMBODIMENTS

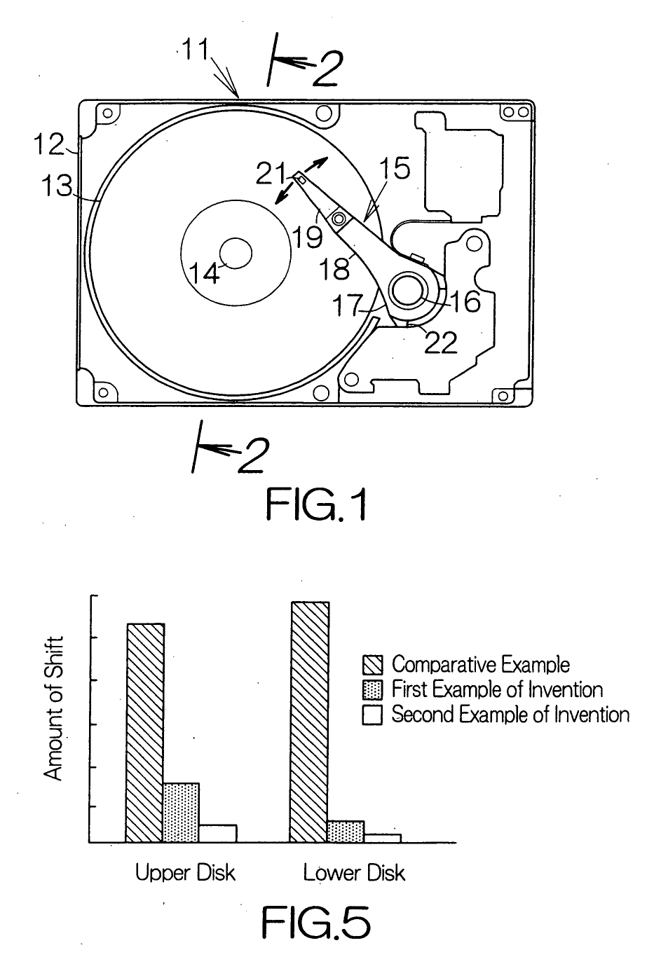

FIG. 1 schematically illustrates the inner structure of a hard disk drive (HDD) 11 as an example of a magnetic recording disk drive or storage device according to an embodiment of the present invention. The HDD 11 includes a box-shaped main enclosure 12 defining an inner space of a flat parallelepiped, for example. At least one magnetic recording disk 13 is contained within the main enclosure 12. The magnetic recording disk or disks 13 is mounted on the driving shaft of a spindle motor 14. The spindle motor 14 is allowed to drive the magnetic recording disk or disks 13 for rotation at a higher revolution speed such as 5,400 rpm, 7,200 rpm, 10,000 rpm, or the like, for example. A cover, not shown, is coupled to the main enclosure 12 so as to define the closed inner space between the main enclosure 12 and the cover itself.

A head actuator 15 is also contained in the inner space of the main enclosure 12. The head actuator 15 includes an actuator block 17. The actuator block 17 is supported on a vertical support shaft 16 for relative rotation. Rigid actuator arms 18 are defined in the actuator block 17. The individual actuator arm 18 is designed to extend in the horizontal direction from the vertical support shaft 16. The actuator arms 18 are related to the front and back surfaces of the magnetic recording disk 13. Casting process may be employed to form the actuator block 17, for example. Aluminum may be employed in this case.

Elastic head suspensions 19 are fixed to the corresponding tip ends of the actuator arms 18 so as to further extend in the forward direction from the actuator arms 18. A flying head slider 21 is supported at the front or tip end of the elastic head suspension 21. The flying head slider 21 is in this manner coupled to the actuator block 17. The flying head slider 21 is opposed to the surface of the magnetic recording disk 13.

An electromagnetic transducer, not shown, is mounted on the flying head slider 21. The electromagnetic transducer may comprise a read element and a write element. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. The write element may include a thin film magnetic head designed to write magnetic bit data into the magnetic recording disk 13 by utilizing a magnetic field induced at a thin film coil pattern.

The elastic head suspension 19 serves to urge the flying head slider 21 toward the surface of the magnetic recording disk 13. When the magnetic recording disk 13 rotates, the flying head slider 21 is allowed to receive airflow generated along the rotating magnetic recording disk 13. The airflow serves to generate a positive pressure or lift on the flying head slider 21. The flying head slider 21 is thus allowed to keep flying above the surface of the magnetic recording disk 13 during the rotation of the magnetic recording disk 13 at a higher stability established by the balance between the urging force of the elastic head suspension 19 and the lift.

A power source 22 such as a voice coil motor (VCM) is connected to the actuator block 17, for example. The actuator block 17 is allowed to rotate around the support shaft 16 based on the operation of the power source 22. The rotation of the actuator block 17 enables the swinging movement of the actuator arms 18 and the elastic head suspensions 19. When the actuator arms 18 swing around the support shaft 16 during the flight of the flying head sliders 21, the flying head sliders 21 are allowed to move in the radial direction of the magnetic recording disk or disks 13. As conventionally known, in the case where two or more of the magnetic recording disk 13 are incorporated within the main enclosure 12, a pair of the actuator arm 18, namely a pair of the elastic head suspension 19 is located between the adjacent ones of the magnetic recording disks 13.

Concentric recording circles or tracks are defined on the front and back surfaces of the magnetic recording disk 13 around the center of the magnetic recording disk 13. Servo signals are established on the magnetic recording disk 13 so as to establish the recording tracks. The servo signals are utilized to form a circular shape of the recording track. The electromagnetic transducer on the flying head slider 21 follows the recording tracks when binary data is to be written into or read out of the magnetic recording disk 13.

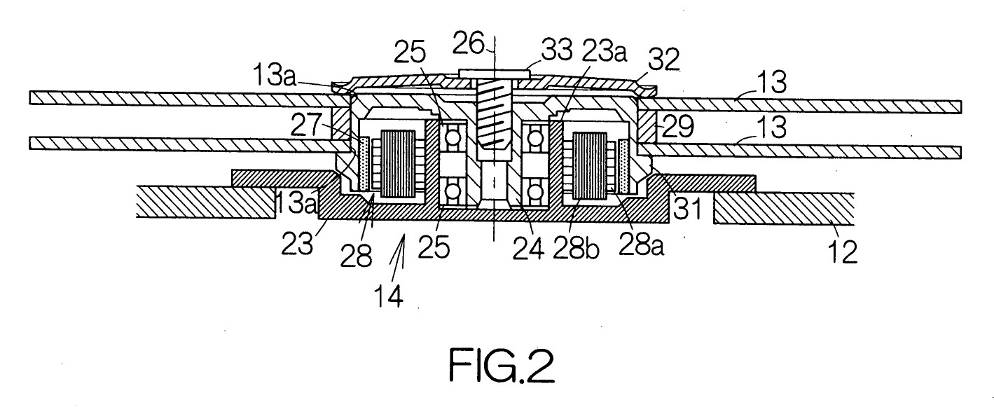

As shown in FIG. 2, the spindle motor 14 includes a motor base 23 fixed to the bottom plate of the main enclosure 12. A sleeve 23a is formed on the motor base 23. The sleeve 23a is designed to stand from the upper surface of the motor base 23 in the vertical direction. A spindle hub 24 as a rotary body is mounted on the sleeve 23a. The spindle hub 24 is received in the sleeve 23a through upper and lower ball bearings 25, 25. The spindle hub 24 is in this manner coupled to the motor base 23 for relative rotation around a predetermined central axis 26.

The spindle hub 24 is designed to define an inward surface opposed to the outward surface or cylindrical outer surface of the sleeve 23a. Permanent magnets 27 are fixed to the inward surface of the spindle hub 24. A group of stator 28 is fixed to the outward surface of the sleeve 23a. The individual stator 28 includes a core 28a made of a layered metallic thin plate and a coil 28b wound around the core 28a, for example. When electric current is supplied to the coils 28b, a magnetic field is generated at the coils 28b so that the spindle hub 24 is driven to rotate around the central axis 26.

A pair of magnetic recording disk 13, 13 is for example mounted on the spindle hub 24. Through holes 13a, 13a are formed in the magnetic recording disks 13, 13, respectively. The spindle hub 24 is received in the through holes 13a, 13a. Here, a clearance is provided between the inner diameter of the through hole 13a and the outer diameter of the spindle hub 24. An annular spacer 29 is interposed between the magnetic recording disks 13, 13 around the spindle hub 24. The annular spacer 29 serves to keep a predetermined space between the magnetic recording disks 13, 13.

A flange 31 is formed on the spindle hub 24 at the lower end of the spindle hub 24. The flange 31 is designed to extend outward. The lower magnetic recording disk 13 is received on the flange 31. A clamp 32 is attached to the upper end of the spindle hub 24. A screw 33 may be employed to fix the clamp 32 to the spindle hub 24, for example. The magnetic recording disks 13, 13 and the annular spacer 29 are thus interposed between the flange 31 and the clamp 32.

FIG. 3 illustrates a fixing mechanism according to a first embodiment of the present invention. The fixing mechanism includes a resin film or resin sheet 34 interposed between the annular spacer 29 and the magnetic recording disks 13, 13. Specifically, the resin sheet 34 is interposed between the upper magnetic recording disk 13 and the annular spacer 29 and between the annular spacer 29 and the lower magnetic recording disk 13. Here, the annular spacer 29 serves as a first fixing member according to the present invention. The clamp 32 and the flange 32 serve as a second fixing member according to the present invention.

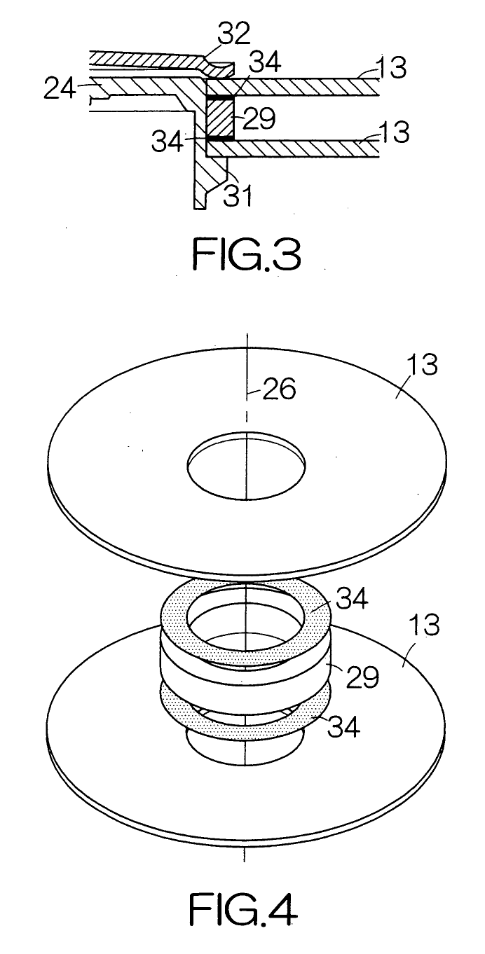

A material having a higher coefficient of friction is employed to form the resin sheet 34, for example. In this case, polyimide resin can be employed as the material. The resin sheet 34 is designed to have a predetermined elasticity. As shown in FIG. 4, the shape of the resin sheet 34 corresponds to the shape of the upper and lower surfaces of the annular spacer 29.

Since the clearance is provided between the inner diameter of the through hole 13a and the outer diameter of the spindle hub 24 in the aforementioned HDD 11, the magnetic recording disks 13 are easily mounted on the spindle hub 24 when the HDD 11 is to be assembled. Productivity is thus improved. Moreover, the resin sheets 34 serve to enhance the friction between the annular spacer 29 and the magnetic recording disks 13, 13 in the fixing mechanism. The center of the concentric recording tracks is reliably kept at the central axis 26 even if impact is applied to the HDD 11. The magnetic recording disks 13 are thus reliably prevented from shifting within a plane perpendicular to the central axis 26 of the spindle hub 24.

On the contrary, if the resin sheets 34 are not interposed between the annular spacer 29 and the magnetic recording disks 13, the magnetic recording disks 13 tend to shift within the aforementioned plane. The shift of the magnetic recording disk 13 induces an eccentricity of the recording tracks to the central axis 26 of the spindle hub 24. If the amount of the shift exceeds the track pitch, the electromagnetic transducer on the flying head slider 21 cannot follow the recording tracks. In particular, in the case where the single screw 33 is employed to fix the clamp 32 on the spindle hub 24 in the aforementioned manner, the clamp 32 cannot establish a larger urging force acting on the magnetic recording disks 13 and the annular spacer 29. In this case, the aforementioned resin sheets 34 sufficiently serve to prevent a shift of the magnetic recording disks 13.

Texture may be formed on the surface of the resin sheet 34 in the aforementioned fixing mechanism. For example, stripes of grooves may be formed on the surface of the resin sheet 34. The texture further enhances the friction between the annular spacer 29 and the magnetic recording disks 13, 13. The magnetic recording disks 13 are thus further reliably prevented from shifting in the horizontal direction.

The inventors have examined the shift of the magnetic recording disks 13 in the HDD 11 based on a simulation on a computer. Two examples of the invention and one comparative example were prepared in the examination. The first example of the invention allowed interposal of the resin sheets 34 between the annular spacer 29 and the magnetic recording disks 13, 13. The raw surface was kept on the resin sheets 34. The second example of the invention likewise allowed interposal of the resin sheets 34 between the annular spacer 29 and the magnetic recording disks 13, 13. Texture was formed on the surface of the resin sheets 34 in the second example. No resin sheets 34 were interposed in the comparative example. An impact of 1,000 [G] was applied to the upper and lower magnetic recording disks 13, 13 within planes perpendicular to the central axis 26 of the spindle hub 24. As shown in FIG. 5, the magnetic recording disks 13, 13 of the first example have enjoyed a reduction in the shift within the planes as compared with the comparative example. In particular, the magnetic recording disks 13, 13 of the second example have enjoyed a still further reduction in the shift.

The resin sheet 34 may be interposed between the flange 31 and the magnetic recording disk 13 as well as between the magnetic recording disk 13 and the clamp 32. In these cases, the flange 31 and the clamp 32 serve as a first fixing member according to the present invention. If only a single one of the magnetic recording disk 13 is mounted on the spindle hub 24, the resin sheet 34 may be interposed between the flange 31 and the magnetic recording disk 13 as well as between the magnetic recording disk 13 and the clamp 32. Otherwise, if three or more of the magnetic recording disks 13 are mounted on the spindle hub 24, upper and lower ones of the annular spacers 29 are allowed to serve as first and second fixing members according to the present invention.

The resin sheet 34 may be adhered by adhesive on the surface of the annular spacer 29 and/or the surface of the magnetic recording disk 13. Alternatively, the resin sheet 34 may be embedded in the surface of the annular spacer 29 and/or the surface of the magnetic recording disk 13. The resin sheet 34 may be replaced with an elastic sheet such as a rubber sheet. Otherwise, texture may be established on the surface of the magnetic recording disk 13. The resin sheet 34 covering over the texture serves to prevent generation of dusts due to destruction of the texture.

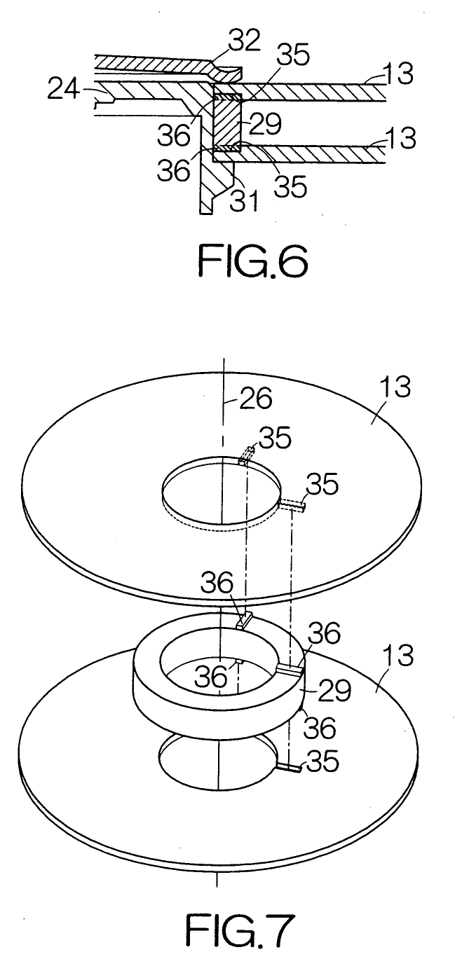

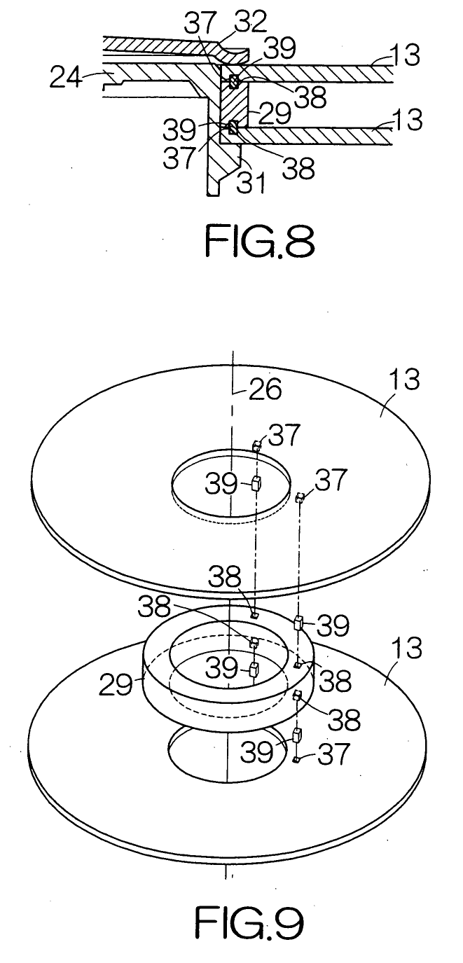

FIG. 6 illustrates a fixing mechanism according to a second embodiment of the present invention. The fixing mechanism is designed to employ a key groove 35 formed on the magnetic recording disk 13. In this case, the key grooves 35 extend in the radial direction from the inner periphery of the magnetic recording disk 13. The key groove 35 corresponds to a key hole according to the present invention. Key members 36 are correspondingly formed on the annular spacer 29. The key members 36 may be integral to the annular spacer 29. For example, when the magnetic recording disk 13 is overlaid on the annular spacer 29, as is apparent from FIG. 7, the key members 36 are received into the corresponding key grooves 35. Here, the annular spacer 29 serves as a first fixing member according to the present invention. Like reference numerals are attached to components or structure equivalent to those of the aforementioned embodiment.

The key members 36 are fitted into the corresponding key grooves 35 in the fixing mechanism of the type. A reliable fixation can be established between the annular spacer 29 and the magnetic recording disk 13. Even if an impact is applied to the HDD 11, the center of the concentric recording tracks is reliably kept at the central axis 26. The magnetic recording disks 13 are thus reliably prevented from shifting within a plane perpendicular to the central axis 26 of the spindle hub 24.

FIG. 8 illustrates a fixing mechanism according to a third embodiment of the present invention. The fixing mechanism is designed to employ key holes 37, 38 formed in the magnetic recording disk 13 and the annular spacer 29. Key members or pins 39 are fixed in the annular spacer 29. The pins 39 are received into the key holes 38 of the annular spacer 29. For example, when the magnetic recording disk 13 is overlaid on the annular spacer 29, as is apparent from FIG. 9, the pins 39 are allowed to get into the corresponding key holes 37 of the magnetic recording disk 13. Here, the annular spacer 29 serves as a first fixing member according to the present invention. Like reference numerals are attached to components or structure equivalent to those of the aforementioned embodiment.

The pins 39 are fitted into the corresponding key hole 37 of the magnetic recording disk 13 in the fixing mechanism of the type. A reliable fixation can be established between the annular spacer 29 and the magnetic recording disk 13. Even if an impact is applied to the HDD 11, the center of the concentric recording tracks is reliably kept at the central axis 26. The magnetic recording disks 13 are thus reliably prevented from shifting within a plane perpendicular to the central axis 26 of the spindle hub 24.

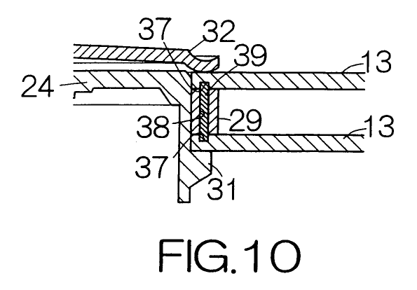

As shown in FIG. 10, the pin 39 may penetrate through the annular spacer 29, for example. Alternatively or concurrently, the pin 39 may penetrates through the magnetic recording disk 13. The fixing mechanism of the type enables a further reliable fixation between the annular spacer 29 and the magnetic recording disk 13. The pin 39 may be shaped into a column, a prism, or the like.

The key member 36 and the pin 39 may be fixed to the flange 32 and/or clamp 32 in the aforementioned fixing mechanisms. In these cases, the flange 31 and the clamp 32 serve as a first fixing member according to the present invention. If only a single one of the magnetic recording disk 13 is mounted on the spindle hub 24, the key member 36 and the pin 39 may likewise be fixed to the flange hub 24 and/or clamp 32. Otherwise, if three or more of the magnetic rerecording disk 13 are mounted on the spindle hub 24, upper and lower one of the annular spacers 29 are allowed to serve as first and second fixing members according to the present invention.

The aforementioned fixing mechanisms may be applied to a recording disk drive such as an optical disk drive, in addition to the aforementioned hard disk drive.

1-7. (canceled)

8. A fixing mechanism comprising:
a rotary body;
a recording medium mounted on the rotary body;
first and second fixing members sandwiching the recording medium around the rotary body;
a key hole formed in one of the first fixing member and the recording medium; and
a key member fixed to other of the first fixing member and the recording medium, said key member designed to get into the key hole.

9. The fixing mechanism according to claim 8, wherein said first fixing member is a spacer interposed between a pair of the recording medium around the rotary body.

10. The fixing mechanism according to claim 9, wherein said key member is integral to said other of the first fixing member and the recording medium.

11. The fixing mechanism according to claim 9, wherein said key member is a pin penetrating through at least one of the first fixing member and the recording medium.
